(19) United States
(12) Patent Application Publication
(10) Pub. No.: US 2025/0381535 A1
(43) Pub. Date: Dec. 18, 2025

(54) MIXER ATTACHMENT

(71) Applicant: WHIRLPOOL CORPORATION, BENTON HARBOR, MI (US)

(72) Inventors: John W. McConnell, St. Joseph, MI (US); John J. Myers, Saugatuck, MI (US); Ryan J. Rutter, St. Joseph, MI (US); Aaron J. Snyder, St. Joseph, MI (US)

(73) Assignee: WHIRLPOOL CORPORATION, BENTON HARBOR, MI (US)

(21) Appl. No.: 18/745,105

(22) Filed: Jun. 17, 2024

(51) Int. Cl. B01F 27/1125; A47J 43/044; A47J 43/07; B01F 101/00

(52) U.S. Cl. CPC B01F 27/11253; A47J 43/0711; A47J 2043/04454; B01F 2101/1805

(57) ABSTRACT

A whisk apparatus for a mixer. The whisk apparatus includes a connection head configured to attach to the mixer. A blade assembly extends about an axis to a tip. The blade assembly includes a plurality of blades spaced around the axis, each blade extends from a first end attached to the connection head, along a blade body, to the tip. A first paddle extends circumferentially from each of the plurality of blade bodies, the first paddles are at least partially aligned along the axis.

### FIELD OF THE DISCLOSURE

The present disclosure generally relates to an attachment for a mixer, and, more particularly, a whisk apparatus.

### BACKGROUND

Mixers, such as hand mixers and stand mixers, generally include a gear-driven mechanism that can selectively connect to a variety of attachments. These attachments are generally utilized for stirring, mixing, and beating different types of foods and different stages of preparation. The gear-driven mechanism is typically motor driven and reduces the physical demands of preparation. Hand mixers typically include a handle and are operated by holding the handle and moving the hand mixture with respect to the food. Stand mixers, on the other hand, are typically a countertop appliance that includes a base, a stirring bowl, and a head that locates and supports the attachment within the bowl. Stand mixers are typically utilized instead of hand mixers for use with dense foods, for example, dough, batter, creams, butter, meringue, and ice cream.

One common attachment for mixers is a whisk attachment that can be utilized for creating creams, butter, meringue, from liquids, fats, sugar, and the like. While mixers and whisk attachments simplify food preparation, whisk attachments rotating at high speeds are known to create messes and certain types of food preparation can be time consuming. Accordingly, the present disclosure relates to a whisk apparatus.

### SUMMARY OF THE DISCLOSURE

According to one aspect of the present disclosure, a whisk apparatus for a mixer includes a connection head configured to attach to the mixer. A blade assembly extends about an axis to a tip. The blade assembly includes a plurality of blades spaced around the axis, each blade extends from a first end attached to the connection head, along a blade body, to the tip. A first paddle extends circumferentially from each of the plurality of blade bodies, the first paddles are at least partially aligned along the axis.

According to another aspect of the present disclosure, a whisk apparatus for a mixer includes a connection head configured to attach to the mixer. A blade assembly extends about an axis to a tip. The blade assembly includes a plurality of blades spaced around the axis, each blade extends from a first end attached to the connection head, along a blade body to a bend at least partially defining the tip, to a second end attached to the connection head. A first paddle extends circumferentially from each of the plurality of blade bodies proximate the bend, and a second paddle extends circumferentially from each of the plurality of blade bodies proximate an opposite side of the bend from the first paddles.

According to yet another aspect of the present disclosure, a whisk apparatus for a mixer includes a connection head configured to attach to the mixer. A blade assembly extends about an axis to a tip. The blade assembly includes a plurality of blades spaced around the axis, each blade extends from a first end attached to the connection head, along a blade body, to the tip. A first paddle extends circumferentially from each of the plurality of blade bodies. The first paddles define an exterior edge spaced from an interior edge facing radially inwardly with respect to the axis. The space between the exterior edge and the interior edge widen radially inwardly towards the axis.

These and other features, advantages, and objects of the present disclosure will be further understood and appreciated by those skilled in the art by reference to the following specification, claims, and appended drawings.

### BRIEF DESCRIPTION OF THE DRAWINGS

In the drawings:

FIG. 1 is an upper perspective view of a whisk apparatus, in accordance with an aspect of the disclosure;

FIG. 2 is a bottom view of a whisk apparatus, in accordance with an aspect of the disclosure;

FIG. 3 is an enlarged partial side elevational view of a plurality of blades of a whisk apparatus, in accordance with an aspect of the disclosure;

FIG. 4A is a top cross-sectional view of an upper portion of a plurality of paddles of a whisk apparatus, in accordance with an aspect of the disclosure;

FIG. 4B is a top cross-sectional view of a lower portion of a plurality of paddles of a whisk apparatus, in accordance with an aspect of the disclosure;

FIG. 5 is a top plan view of a whisk apparatus, in accordance with an aspect of the disclosure;

FIG. 6 is a side elevational view of a stand mixer with a bowl and a splash guard, in accordance with an aspect of the disclosure; and

FIG. 7 is a side cross-sectional view of a splash guard, in accordance with an aspect of the disclosure.

The components in the figures are not necessarily to scale, emphasis instead being placed upon illustrating the principles described herein.

### DETAILED DESCRIPTION

The present illustrated embodiments reside primarily in a whisk apparatus for a mixer. Accordingly, the apparatus components and method steps have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

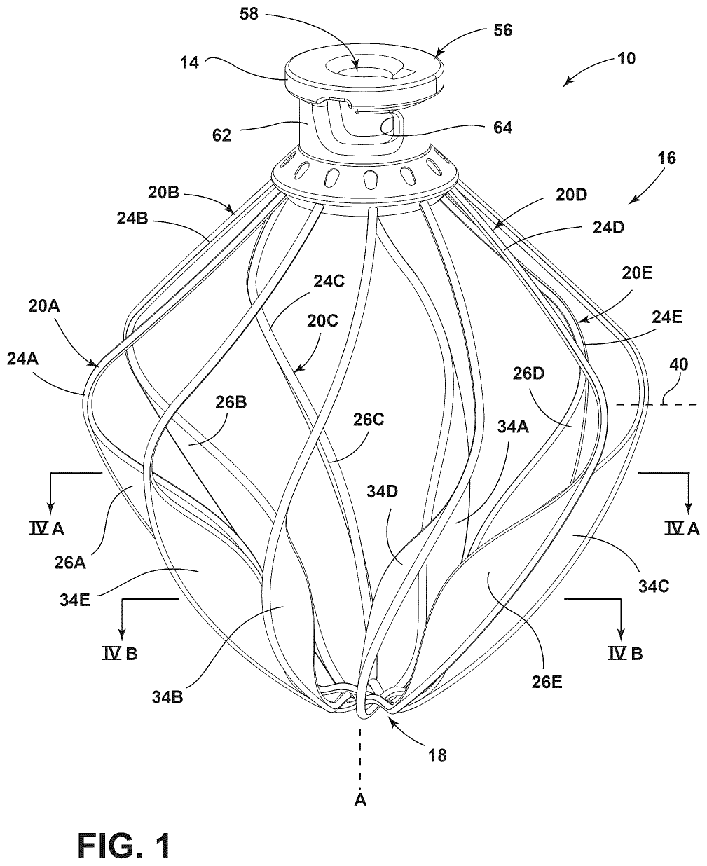

For purposes of description herein, the terms “upper,” “lower,” “right,” “left,” “rear,” “front,” “vertical,” “horizontal,” and derivatives thereof shall relate to the disclosure as oriented in FIG. 1. Unless stated otherwise, the term “front” shall refer to the surface of the element closer to an intended viewer and/or user, and the term “rear” shall refer to the surface of the element further from the intended viewer and/or user. However, it is to be understood that the disclosure may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

The terms “including,” “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises a . . . ” does not, without more constraints, preclude the existence of additional identical elements in the process, method, article, or apparatus that comprises the element.

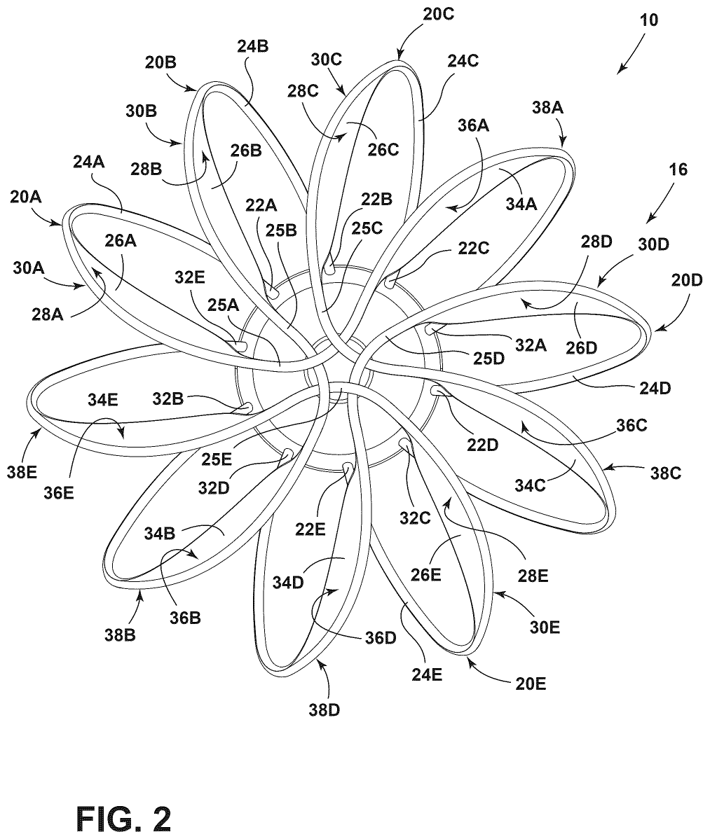

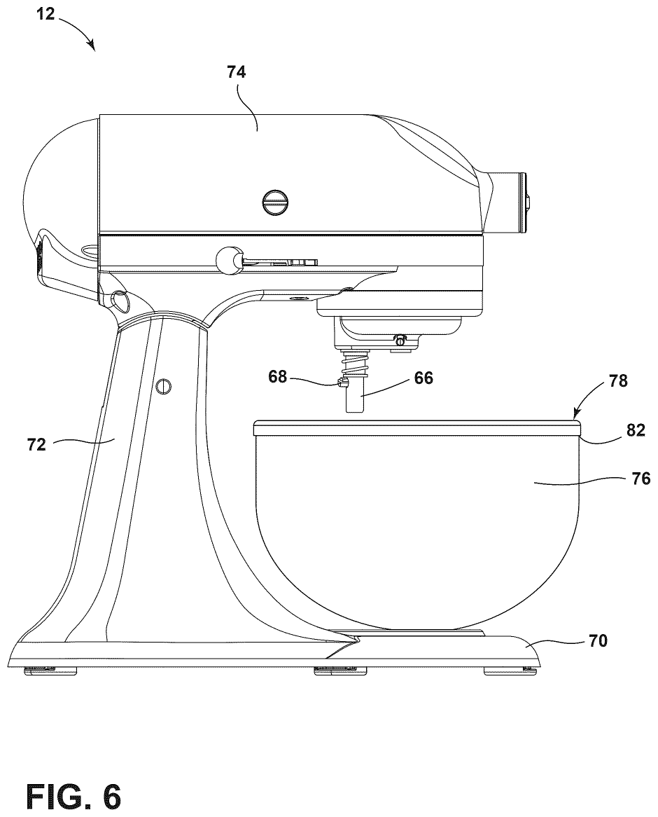

Referring initially to FIGS. 1-2, reference numeral 10 generally designates a whisk apparatus for a mixer 12 (FIG. 6). The whisk apparatus 10 includes a connection head 14 configured to attach to the mixer 12. A blade assembly 16 extends about an axis A to a tip 18. The blade assembly 16 includes a plurality of blades 20A-20E spaced around the axis A, each blade 20A-20E extends from a first end 22A-22E attached to the connection head 14, along a blade body 24A-24E, to the tip 18. A first paddle 26A-26E extends circumferentially from each of the plurality of blade bodies 24A-24E, the first paddles 26A-26E are at least partially aligned along the axis A.

With continued reference to FIGS. 1-2, each first paddle 26A-26E defines a front surface 28A-28E and a rear surface 30A-30E. The front surfaces 28A-28E may face a direction of rotation by the mixer 12 and at least partially angled in a direction towards the tip 18. More particularly, when the whisk apparatus 10 is coupled to the mixer 12, the mixer 12 rotates the whisk apparatus 10 with the front surfaces 28A-28E facing forward. In this manner, food stuff being mixed is deflected in a downward direction, reducing splashing, and facilitating mixing. In some embodiments, each blade 20A-20E may extend from a first end 22A-22E attached to the connection head 14, along a blade body 24A-24E to a bend 25A-25E at least partially defining the tip 18, to a second end 32A-32E attached to the connection head 14. A second paddle 34A-34E may extend from each of the plurality of blade bodies 24A-24E on an opposite side of the tip 18 than the first paddles 26A-26E. The first paddles 26A-26E and second paddles 34A-34E may at least partially aligned along the axis A. In some embodiments, the first paddles 26A-26E and second paddles 34A-34E are substantially (e.g., fully) aligned along the axis A. Each second paddle 34A-34E, may, likewise, define a front surface 36A-36E and a rear surface 38A-38E, with the front surface 36A-36E facing a direction of rotation by the mixer 12 and at least partially angled in a direction of the tip 18. In this manner, food stuff being mixed is deflected in a downward direction, reducing splashing, and facilitating mixing.

With continued reference to FIGS. 1-2, the first paddles 26A-26E and second paddles 34A-34E may each define the same shape and orientation arrayed around the axis A. More particularly, the plurality of blades 20A-20E may extend from the connection head 14 radially outwardly to a middle body curve 40 and extend from the middle body curve 40 radially inwardly towards the tip 18. The first paddles 26A-26E and second paddles 34A-34E may be located on a portion of the blade bodies 24A-24E between the middle body curve 40 and the tip 18. As depicted, the first paddles 26A-26E and second paddles 34A-34E may terminate before the tip 18 (e.g., be spaced proximate from the tip 18 by a portion of the blade bodies 24A-24E). In some embodiments, the first paddles 26A-26E and second paddles 34A-34E may be integrally formed with the blade bodies 24A-24E.

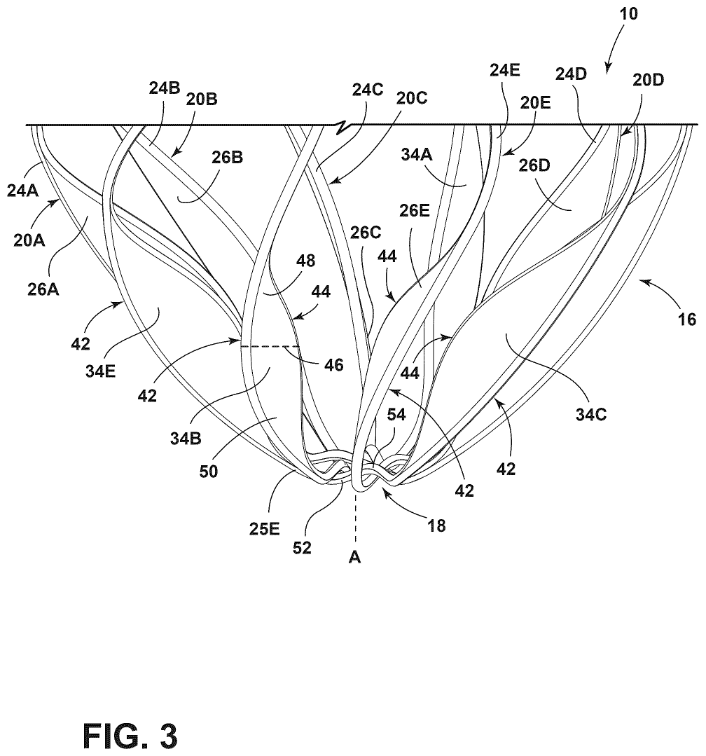

With reference now to FIG. 3, the first paddles 26A-26E and the second paddles 34A-34E may each define an exterior edge 42 spaced from an interior edge 44 facing radially inwardly with respect to the axis A. The space between the exterior edge 42 and the interior edge 44 may widen. For example, the space between the exterior edge 42 and the interior edge 44 may widen radially inwardly towards the axis A. In some embodiments, the interior edge 44 is curved and the space between the exterior edge 42 and the interior edge 44 widens from the connection head 14 towards the tip 18 until a paddle midpoint 46, where the space between the exterior edge 42 and the interior edge 44 becomes smaller towards the tip 18. The paddle midpoint 46 may be substantially centrally located on the first paddles 26A-26E and the second paddles 34A-34E along the axis A. However, it should be appreciated that the paddle midpoint 46 may be located on the first paddles 26A-26E and the second paddles 34A-34E along the axis A non-centrally.

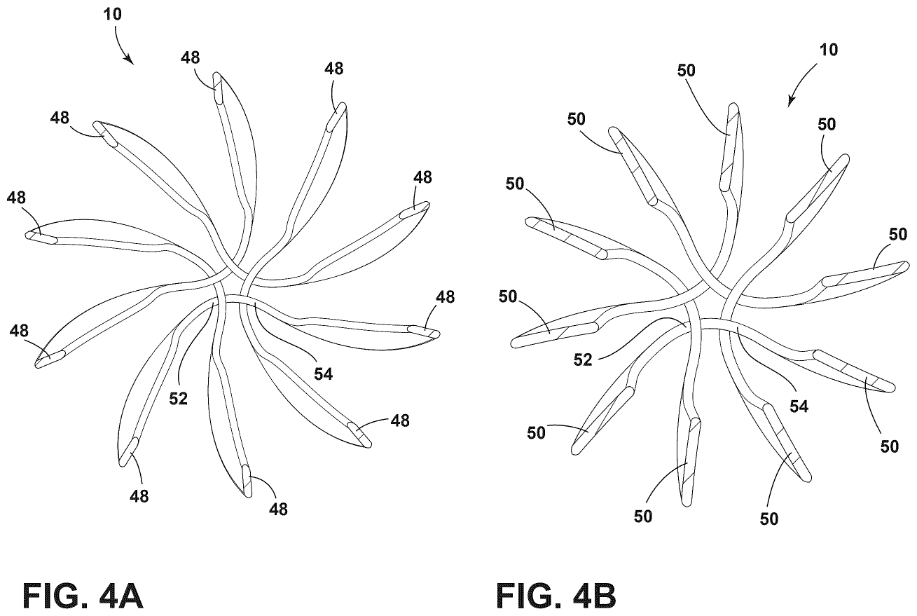

With continued reference to FIGS. 3-4B, each blade body 24A-24E, the first paddles 26A-26E, and the second paddles 34A-34E may be serpentine shaped along the axis A. More particularly, each of the first paddles 26A-26E and the second paddles 34A-34E may define a top portion 48 (e.g., between the paddle midpoint 46 and the connection head 14) and a bottom portion 50 (e.g., between the paddle midpoint 46 and the tip 18). The top portion 48 and the bottom portion 50 may be angled in a direction of the tip 18. More particularly, the angle defined by the top portion 48 may be greater (e.g., on average) than the angle defined by the bottom portion 50 (e.g., on average). More particularly, the angle defined by the top and bottom portion 48, 50 may generally become less along the top portion 48 to the bottom portion 50 along an entire length of the first paddles 26A-26E and the second paddles 34A-34E. The orientation of the exterior edge 42 with respect to the interior edge 44 may change along the axis A. More particularly, the front surfaces 28A-28E of the first paddles 26A-26E and the front surfaces 36A-36E of the second paddles 34A-34E may corkscrew in a direction away from the axis A as the first paddles 26A-26E and the second paddles 34A-34E become closer to the tip 18. In this manner, the top portion 48 may generally deflect foodstuff in an inward and downward direction, while the bottom portion 50 may generally direct foodstuff in an outward and downward direction. The blade bodies 24A-24E are generally thin in portions other than the first paddles 26A-26E and the second paddles 34A-34E (e.g., defining a cylindrical cross-section). In this manner, foodstuff introduced over the middle body curve 40 can pass through the thin portions of the blade bodies 24A-24E towards the tip 18.

The blade bodies 24A-24E may be interwoven. For example, the bend 25A-25E on each blade body 24A-24E may be threaded over the bend 25A-25E of at least one other blade and under the bend 25A-25E of at least one other blade. More particularly, the bend 25A-25E on each blade body 24A-24E may be threaded over the bend 25A-25E of a first adjacent blade and under the bend 25A-25E of a second adjacent blade. In this manner, the first end 22A-22E and the second end 32A-32E of each blade 20A-20E may be spaced by the first end 22A-22E of the first adjacent blade and the first end 22A-22E of the second adjacent blade. As such, the first end 22A-22E and the second end 32A-32E of each blade 20A-20E may be connected to the connection head 14 non-diametrically. Each bend 25A-25E may include an upwardly facing bend 52 and a downward facing bend 54. The upward facing bend 52 of one blade body 24A-24E may extend below the downward facing bend 54 of the first adjacent blade body and the downward facing bend 54 may extend above the upward facing bend 52 of the second adjacent blade body. In some embodiments, the first adjacent blade body is a blade body 24A-24E nearest the reference blade body 24A-24E (e.g., in a circumferential direction) and the second adjacent blade body is a blade body 24A-24E second nearest the reference blade body 24A-24E (e.g., in the same circumferential direction). In this manner, the interweaving of the blade bodies 24A-24E prevents radial and circumferential deformation of the blade bodies 24A-24E during usage. However, it should be appreciated that the blade bodies 24A-24E may, rather than or in addition to being threaded, be connected to a central hub member for retraining the shape of the blade assembly 16 during usage and coupling the blade bodies 24A-24E together.

While FIGS. 1-5 depict the blade assembly 16 as having ten paddles (e.g., five first paddles 26A-26E, five second paddles 34A-34E, and five blades 20A-20E), it should be appreciated that other numbers of paddles and blades 20A-20E may be utilized without departing from the scope of the subject disclosure. For example, the whisk apparatus 10 may include two paddles or more, four paddles or more, six paddles or more, eight paddles or more, or ten paddles or more. The number of paddles may be equal to the number of blades 20A-20E or, as depicted, two paddles per blade 20A-20E. Tests comparing the depicted whisk apparatus 10 to a standard whisk (e.g., a whisk without paddles) have shown significant improvements in food processing efficiency. More particularly, the test included mixing about 462g of buttermilk and 434g of butter to form whipped cream. The standard whisk made approximately four cups of whipped cream in about 13 minutes while the whisk apparatus made approximately four cups of whipped cream in about 6 minutes.

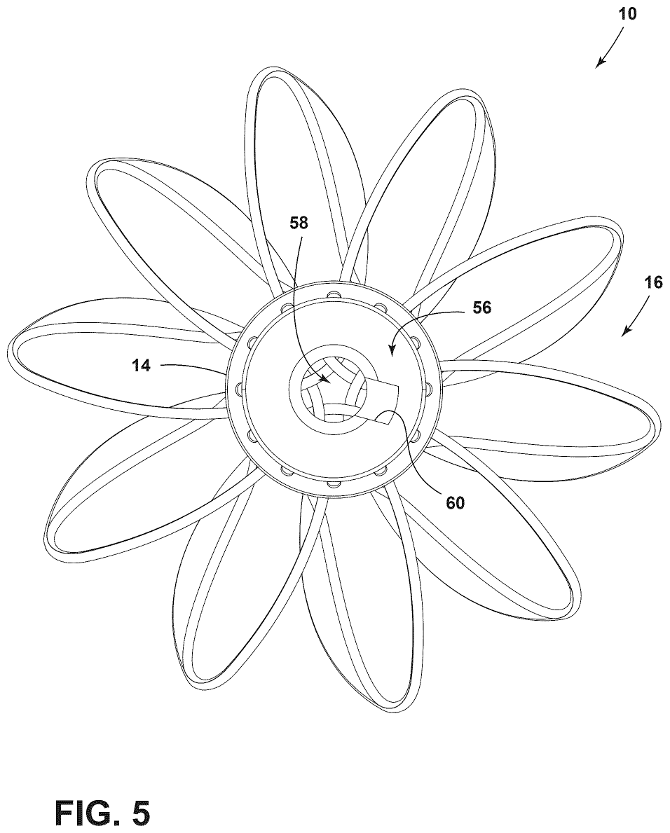

With reference now to FIGS. 5 and 6, the connection head 14 may be configured to selectively attach to the mixer 12. In this manner, other apparatuses and attachments can be interchanged. The mixer 12 may have a variety of configurations. For example, the mixer 12 may be a hand mixer, a stand mixer, and/or the like. In the FIGS. the mixer 12 is depicted as a stand mixer. The connection head 14 may include a top surface 56 defining an insertion hole 58 with a key groove 60 that interlocks with a shaft of the mixer. The insertion hole 58 may extend entirely through the connection head 14 (e.g., to ease cleaning) or may be a blind hole. The connection head 14 may further include a side surface 62 that defines a depression 64 (FIG. 1) in communication with the key groove 60. In this manner, a shaft 66 with a key protrusion 68 may be selectively interlocked with the connection head 14. More particularly, the shaft 66 may be axially aligned with the insertion hole 58 and the key protrusion 68 may be circumferentially aligned with the key groove 60 during an initial insertion. After the initial insertion, the whisk apparatus 10 may be rotated relative to the shaft 66 until the key protrusion 68 becomes interlocked in the depression 64. The mixer 12 may include a base 70 and an appliance body 72 extending from the base 70 to a head 74. The head 74 and base 70 may generally extend in the same direction with respect to the appliance body 72. The shaft 66 extends from the head and a mixing bowl 76 may rest on and/or otherwise be supported by the base 70.

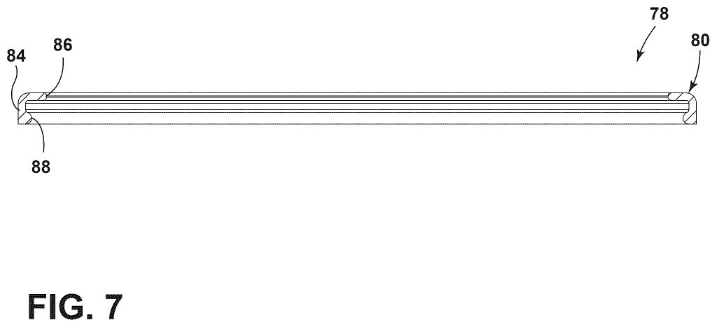

With reference now to FIGS. 6 and 7, in some embodiments, the mixer 12 and/or the whisk apparatus 10 may include and/or the whisk apparatus 10 may otherwise be used in conjunction with a splash guard 78. The splash guard 78 may have an annular body 80 that forms an interference fit with a rim 82 of the mixing bowl 76. The splash guard 78 may be formed of flexible material with elastic memory. As depicted in FIG. x, the splash guard 78 includes a coupling portion 84 that couples to the rim 82 and a guard portion 86 that extends inwardly past the rim 82 to prevent foodstuff from sliding upwardly and outwardly along an interior surface of the mixing bowl 76. The coupling portion 84 may include a gasket 88 that extends radially inwardly. The rim 82 may extend radially outwardly such that it is sandwiched between the guard portion 86 and the gasket 88.

The disclosure herein is further summarized in the following paragraphs and is further characterized by combinations of any and all of the various aspects described therein.

According to one aspect of the present disclosure, a whisk apparatus for a mixer includes a connection head configured to attach to the mixer. A blade assembly extends about an axis to a tip. The blade assembly includes a plurality of blades spaced around the axis, each blade extends from a first end attached to the connection head, along a blade body, to the tip. A first paddle extends circumferentially from each of the plurality of blade bodies, the first paddles are at least partially aligned along the axis.

According to another aspect, each of a plurality of first paddles defines a front surface and a rear surface. The front surface facing a direction of rotation by a mixer and at least partially angled in a direction towards a tip.

According to yet another aspect, each of a plurality of blades extends from a first end attached to a connection head, along a blade body to a bend at least partially defining a tip, to a second end attached to the connection head.

According to still yet another aspect, a second paddle extends from each of a plurality of blade bodies on an opposite side of a tip than a plurality of first paddles. The first and second paddles are at least partially aligned along the axis.

According to another aspect, each of a plurality of first and second paddles defines a front surface and a rear surface, the front surface facing a direction of rotation by the mixer and at least partially angled in a direction towards a tip.

According to yet another aspect, a bend on each blade body is threaded over the bend of a first adjacent blade and under the bend of a second adjacent blade.

According to still yet another aspect, a first end and a second end of each blade is spaced by the first end of a first adjacent blade and the first end of a second adjacent blade.

According to another aspect, a first end and a second end of each blade are connected to a connection head non-diametrically.

According to yet another aspect, each of a plurality of first paddles is integrally formed with the blade body.

According to still yet another aspect, each of a plurality of blade bodies and first paddles are serpentine shaped along an axis.

According to another aspect of the present disclosure, a whisk apparatus for a mixer includes a connection head configured to attach to the mixer. A blade assembly extends about an axis to a tip. The blade assembly includes a plurality of blades spaced around the axis, each blade extends from a first end attached to the connection head, along a blade body to a bend at least partially defining the tip, to a second end attached to the connection head. A first paddle extends circumferentially from each of the plurality of blade bodies proximate the bend, and a second paddle extends circumferentially from each of the plurality of blade bodies proximate an opposite side of the bend from the first paddles.

According to another aspect, a bend on each blade body is threaded over the bend of at least one blade and under the bend of at least one other blade.

According to yet another aspect, each of a plurality of first and second paddles define a front surface and a rear surface. The front surface facing a direction of rotation by a mixer and at least partially angled in a direction towards a tip.

According to yet another aspect, a plurality of blades extends from a connection head radially outwardly to a middle body curve and extend from the middle body curve radially inwardly towards a tip.

According to another aspect, first and second paddles are located on a portion of a plurality of blade bodies between the middle body curve and a tip.

According to yet another aspect, first and second paddles are integrally formed with blade bodies.

According to yet another aspect, a stand mixer includes a whisk apparatus. The whisk apparatus includes a connection head configured to attach to the mixer. A blade assembly extends about an axis to a tip. The blade assembly includes a plurality of blades spaced around the axis, each blade extends from a first end attached to the connection head, along a blade body to a bend at least partially defining the tip, to a second end attached to the connection head. A first paddle extends circumferentially from each of the plurality of blade bodies proximate the bend, and a second paddle extends circumferentially from each of the plurality of blade bodies proximate an opposite side of the bend from the first paddles.

According to yet another aspect of the present disclosure, a whisk apparatus for a mixer includes a connection head configured to attach to the mixer. A blade assembly extends about an axis to a tip. The blade assembly includes a plurality of blades spaced around the axis, each blade extends from a first end attached to the connection head, along a blade body, to the tip. A first paddle extends circumferentially from each of the plurality of blade bodies. The first paddles define an exterior edge spaced from an interior edge facing radially inwardly with respect to the axis. The space between the exterior edge and the interior edge widen radially inwardly towards the axis.

According to another aspect, an interior edge is curved and a space between an exterior edge and the interior edge widens from a connection head towards a tip until a first paddle midpoint, where the space between the exterior edge and the interior edge becomes smaller towards the tip.

According to yet another aspect, each of a plurality of first paddles defines a front surface and a rear surface between an exterior edge and an interior edge. The front surface faces a direction of rotation by a mixer and is at least partially angled in a direction towards a tip.

It will be understood by one having ordinary skill in the art that construction of the described disclosure and other components is not limited to any specific material. Other exemplary embodiments of the disclosure disclosed herein may be formed from a wide variety of materials, unless described otherwise herein.

For purposes of this disclosure, the term “coupled” (in all of its forms, couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an end-point of a range, the disclosure should be understood to include the specific value or end-point referred to. Whether or not a numerical value or end-point of a range in the specification recites “about,” the numerical value or end-point of a range is intended to include two embodiments: one modified by “about,” and one not modified by “about.” It will be further understood that the end-points of each of the ranges are significant both in relation to the other end-point, and independently of the other end-point.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, or within about 2% of each other.

It is also important to note that the construction and arrangement of the elements of the disclosure as shown in the exemplary embodiments is illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements shown as multiple parts may be integrally formed, the operation of the interfaces may be reversed or otherwise varied, the length or width of the structures and/or members or connectors or other elements of the system may be varied, and the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes or steps within described processes may be combined with other disclosed processes or steps to form structures within the scope of the present disclosure. The exemplary structures and processes disclosed herein are for illustrative purposes and are not to be construed as limiting.

What is claimed is:

1. A whisk apparatus for a mixer, the whisk apparatus comprising:
a connection head configured to attach to the mixer; and
a blade assembly extending about an axis to a tip, the blade assembly comprising:
a plurality of blades spaced around the axis, each blade extending from a first end attached to the connection head, along a blade body, to the tip; and
a first paddle extends circumferentially from each of the plurality of blade bodies, the first paddles at least partially aligned along the axis.

2. The whisk apparatus of claim 1, wherein each first paddle defines a front surface and a rear surface, the front surface facing a direction of rotation by the mixer and at least partially angled in a direction towards the tip.

3. The whisk apparatus of claim 1, wherein each blade extends from the first end attached to the connection head, along the blade body to a bend at least partially defining the tip, to a second end attached to the connection head.

4. The whisk apparatus of claim 3, wherein a second paddle extends from each of the plurality of blade bodies on an opposite side of the tip than the first paddles, the first and second paddles at least partially aligned along the axis.

5. The whisk apparatus of claim 4, wherein each first and second paddle defines a front surface and a rear surface, the front surface facing a direction of rotation by the mixer and at least partially angled in a direction towards the tip.

6. The whisk apparatus of claim 3, wherein the bend on each blade body is threaded over the bend of a first adjacent blade and under the bend of a second adjacent blade.

7. The whisk apparatus of claim 6, wherein the first end and the second end of each blade is spaced by the first end of the first adjacent blade and the first end of the second adjacent blade.

8. The whisk apparatus of claim 1, wherein the first end and the second end of each blade are connected to the connection head non-diametrically.

9. The whisk apparatus of claim 1, wherein each first paddle is integrally formed with the blade body.

10. The whisk apparatus of claim 1, wherein each blade body and first paddle are serpentine shaped along the axis.

11. A whisk apparatus for a mixer, the whisk apparatus comprising:
a connection head configured to attach to the mixer; and
a blade assembly extending about an axis to a tip, the blade assembly comprising:
a plurality of blades spaced around the axis, each blade extending from a first end attached to the connection head, along a blade body to a bend at least partially defining the tip, to a second end attached to the connection head; and
a first paddle extends circumferentially from each of the plurality of blade bodies proximate the bend, and a second paddle extends circumferentially from each of the plurality of blade bodies proximate an opposite side of the bend from the first paddles.

12. The whisk apparatus of claim 11, wherein the bend on each blade body is threaded over the bend of at least one blade and under the bend of at least one other blade.

13. The whisk apparatus of claim 11, wherein each of the first and second paddles define a front surface and a rear surface, the front surface facing a direction of rotation by the mixer and at least partially angled in a direction towards the tip.

14. The whisk apparatus of claim 11, wherein the plurality of blades extend from the connection head radially outwardly to a middle body curve and extend from the middle body curve radially inwardly towards the tip.

15. The whisk apparatus of claim 14, wherein the first and second paddles are located on a portion of the blade bodies between the middle body curve and the tip.

16. The whisk apparatus of claim 15, wherein the first and second paddles are integrally formed with the blade bodies.

17. A stand mixer including the whisk apparatus of claim 11.

18. A whisk apparatus for a mixer, the whisk apparatus comprising:
a connection head configured to attach to the mixer; and
a blade assembly extending about an axis to a tip, the blade assembly comprising:
a plurality of blades spaced around the axis, each blade extending from a first end attached to the connection head, along a blade body, to the tip; and
a first paddle extends circumferentially from each of the plurality of blade bodies, the first paddles defining an exterior edge spaced from an interior edge facing radially inwardly with respect to the axis, the space between the exterior edge and the interior edge widening radially inwardly towards the axis.

19. The whisk apparatus of claim 18, wherein the interior edge is curved and the space between the exterior edge and the interior edge widens from the connection head towards the tip until a first paddle midpoint, where the space between the exterior edge and the interior edge becomes smaller towards the tip.

20. The whisk apparatus of claim 18, wherein each first paddle defines a front surface and a rear surface between the exterior edge and the interior edge, the front surface facing a direction of rotation by the mixer and at least partially angled in a direction towards the tip.
